(19) United States
(12) Patent Application Publication
(10) Pub. No.: US 2003/0066276 A1
(43) Pub. Date: Apr. 10, 2003

(54) Mowing machine

(75) Inventors: Bernard Krone, Spelle (DE); Andreas Afting, Emsburen (DE)

Correspondence Address: GUDRUN E. HUCKETT, LONSSTR. 53, WUPPERTAL, 42289, DE

(73) Assignee: Maschinenfabrik Bernard Krone GmbH, Spelle, DE

(21) Appl. No.: 10/065,332

(22) Filed: Oct. 4, 2002

(30) Foreign Application Priority Data
Oct. 6, 2001 (DE) 10149364.9

(51) Int. Cl. A01D 75/30

(52) U.S. Cl. 56/6

(57) ABSTRACT

A mowing machine connectable to a lifting device arranged at the rear of an agricultural support vehicle has a mowing device with several rotary cutting members guided in a working position laterally on the support vehicle. A support beam has a first end receiving the mowing device and a second end with a three-point hitch with connecting locations connectable to upper and lower rods of the lifting device. A first connecting location is provided on the support beam on a side of the three-point hitch remote from the mowing device. The first connecting location is connected to the three-point hitch such that when the mowing device hits an obstacle while moving in a traveling and working direction, a pivot movement of the mowing device in a direction counter to the traveling and working direction and a lifting movement of the leading area of the mowing device are initiated.

### BACKGROUND OF INVENTION

1. Field of the Invention

The invention relates to a mowing machine connectable to a lifting device arranged at the rear end of an agricultural support vehicle, wherein the mowing machine comprises a mowing device which is guided in the working and operating position laterally by the support vehicle and comprises a number of rotary cutting members rotating about an approximately vertical axis. The mowing machine further comprises a support beam configured to receive with one end the mowing device and provided at the other end with a three-point hitch with connecting locations for connecting to upper and lower rods of the lifting device.

2. Description of the Related Art

Such mowing machines are known in various practical embodiments and are used mainly for harvesting grass or similar crops. During harvesting, the mowing device of such a mowing machine is moved at great speed across a field or meadow wherein the mowing device glides across the ground surface or the grass sod. However, since in practice it happens frequently that fields or meadows to be mowed contain rocks or similar obstacles, it is necessary to provide such mowing machines with safety devices which are designed to prevent that the rocks or obstacles damage the mowing device.

From German patent application DE 28 25 678 A1 a suspension mechanism with such a safety device is known. It is comprised of a swivel beam whose first end projects from the contour of the support vehicle and is provided for receiving an agricultural implement while the second end of the swivel beam is provided in order to be connected to one upper arm and one lower arm of a three-point hitch of the support vehicle, the arms being arranged on a side opposite the implement. On the side of the three-point hitch facing the agricultural implement a forwardly projecting console is provided on which the second lower arm of the three-point hitch will rest; this arm is meant to stay there even during normal use and is loaded by means of a pressure spring. Only when the agricultural implement, for example, embodied as a mowing device, impacts on a rock or a similar obstacle, the arm of the three-point hitch facing the mowing device should lift from the projecting console and in this way a return pivoting of the agricultural implement, in the form of a mowing device, is to be performed.

The above described safety device however has a defect in that, as a result of different friction conditions during practical use of an agricultural implement embodied as a mowing device between the ground surface and the mowing device, an exact adjustment of the spring force is not possible and, therefore, a correct working and operating position of the mowing device cannot be adjusted. The mowing device therefore swings back and forth between a theoretically provided working and operating position and a return pivot position so that a clean and satisfactory mowing result cannot be achieved in this way.

### SUMMARY OF INVENTION

It is an object of the present invention to provide a mowing machine of the aforementioned kind which is characterized by a safety device with a constructively simple configuration that enables traversing of rocks or similar obstacles on fields or meadows to be mowed, without causing damage to the mowing machine, in a reliable manner and without impeding the mowing result.

In accordance with the present invention, this is achieved in that the connecting location provided on the support beam on the side of the three-point hitch facing away from the mowing device is connected to the three-point hitch in a way to be yielding such that upon impacting of the mowing device on an obstacle, when moving in the traveling and working direction, a pivot movement of the mowing device in a direction opposite to the traveling and working direction and a lifting (tilting) of the area of the mowing device leading relative to the traveling and working direction are initiated.

In a mowing machine for harvesting grass or similar crops according to the invention, a safety device for protecting a mowing device, that is arranged in the working and operating position laterally on a support vehicle, against damage by rocks or similar obstacles is proposed which in a constructively simple and thus inexpensive way is integrated into a three-point hitch of the mowing machine and in this way uses the ball-and-socket joints provided on upper and lower rods of a lifting device of the support vehicle as swivel joints. In this connection, according to the invention it is proposed to support the mowing device on a first end of a support beam so as to be pivotable while on the second end of the support beam a three-point hitch with connecting locations for upper and lower rods is provided, wherein the connecting location provided at a side of the support beam facing away (remote) from the mowing device is connected yieldingly with the three-point hitch such that, when the mowing device impacts on an obstacle when moving in the traveling and working direction, a pivot movement of the mowing device in a direction opposite to the traveling and working direction and a lifting (tilting) movement of the area of the mowing device leading relative to the traveling and working direction are initiated.

As a result of this type of configuration of a three-point hitch it is made possible that, when the mowing device impacts on a rock, a pivot movement of the mowing device about an axis is carried out which extends from the connecting location of the lower rod facing the mowing device to the connecting location of the upper rod. This pivot movement is comprised of two partial movements wherein a first partial movement is carried out as a pivot movement of the mowing device in a plane extending parallel to the ground surface but in a direction opposite to the traveling and working direction, while the second partial movement is carried out as a lifting movement of the area of the mowing device leading in the traveling and working direction. The mowing device thus carries out a tilting movement about a horizontal axis extending transversely to the traveling and working direction so that in this way traversing of a rock or a similar obstacle is significantly facilitated. In order to achieve this effect, according to the invention it is provided that the connecting location on the side of the three-point hitch facing away from the mowing device is connected to the three-point hitch so as to yield in a direction opposite to the traveling and working direction, wherein the connection between the connecting location and the three-point hitch is released (yields) only upon surpassing a predetermined securing force. This securing force, which is to be considered a threshold or limit, effects that the mowing device in practical use is always maintained in the provided working and operating position so that optimal mowing results are ensured.

In an advantageous embodiment of a mowing machine provided with the features according to the invention, the connecting location at the side of the three-point hitch facing away from the mowing device is configured as a three-member rod arrangement which is comprised of a rod provided with at least one lower rod journal which is supported by a strut which is yielding with regard to its length. The rod is arranged such that it is pivotable from its initial position in a direction opposite to the traveling and working direction. However, before this pivot movement can occur, first a predetermined securing force must be overcome. This securing force is applied, for example, by a strut which is a pressure strut which is comprised of two sections which can be inserted into one another wherein the inner section is secured in its initial position by a locking pawl which is pretensioned by a pressure spring and cooperates with a securing pawl provided on the outer section. The strut has its maximum length in the initial position. As a stationary base member of the rod arrangement a support arm is provided which is fixedly connected with the support beam of the mowing machine. In this connection, it is of no consequence with regard to the function of the device of the invention whether this rod arrangement is arranged above or below the support arm, as long as this is possible with respect to the provided mounting space. The pretension of the pressure spring is adjustable for adaptation to different working and operating conditions.

According to an advantageous embodiment of the invention, it may be provided that the support of the rod of the rod arrangement is configured such that the lower rod journal(s) of the connecting location on the side of the three-point hitch facing away (remote) from the mowing device, upon pivot movement of the rod from its initial position, follows at least partially the pivot movement of the mowing device when impinging on a rock or similar obstacle. This means that during the pivot movement of the mowing device, which is initiated when impacting on a rock or a similar obstacle and whose pivot point is within the area of the lower rod journal(s) of the connecting location on the side of the three-point hitch facing (proximal to) the mowing device, the rod of the rod arrangement is pivoted from its initial position in opposite direction to the traveling and working direction and the lower rod journal(s) of the connecting location on the side facing away from the mowing device is/are moved approximately on a circular path about the lower rod journal(s) of the connecting location on the side facing the mowing device. In this way, stress between the lower rods of the lifting device which are laterally locked during practical use is advantageously prevented.

In order to obtain these follower properties, the support of the rod of the rod arrangement is such that an axis extending through a bearing journal of the rod of the rod arrangement is arranged at an angle relative to a central axis extending through the lower rod journals of the connecting locations and, in this way, at least in the area of the lower rod journal of the connecting location on the side of the three-point hitch facing (proximal to) the mowing device, intercepts this central axis. When employing two lower rod journals, the axis of the bearing journal of the rod can be aligned according to the invention such that it intercepts the central axis, extending through the lower rod journals, in an area arranged approximately centrally between the lower rod journals of the connecting location on the side of the three-point hitch facing the mowing machine.

A further advantageous aspect of the invention can result by employing a hydraulic piston-cylinder arrangement loadable by a pressure force as a strut in the rod arrangement, wherein the hydraulic piston-cylinder arrangement cooperates by means of its pressure connector with a hydraulic storage device. This makes it possible to provide an automatic return of the strut to reach its initial length, for example, the moving device has impinged on and traversed a rock or a similar obstacle.

In a further conceivable embodiment it may be provided that the connecting location on the side of the three-point hitch facing away from the mowing device is connected to a support arm which is configured to be changeable with regard to its length in a telescoping fashion. In this connection, springs or similar force storage means can be employed in order to secure the support arm in an extended position and to allow a transfer into the retracted position only upon surpassing a predetermined securing force.

### BRIEF DESCRIPTION OF DRAWINGS

FIG. 1 is a perspective illustration of a mowing machine according to the invention in the working and operating position.

FIG. 2 is a prospective illustration of the mowing machine according to the invention after an overload situation with the mowing device pivoted in a direction counter to the traveling and working direction.

FIG. 3 is an enlarged view of the main features of a three-point hitch of the mowing machine according to the invention.

FIG. 4 is an enlarged view of an embodiment of a strut of a rod arrangement of the three-point hitch.

### DETAILED DESCRIPTION

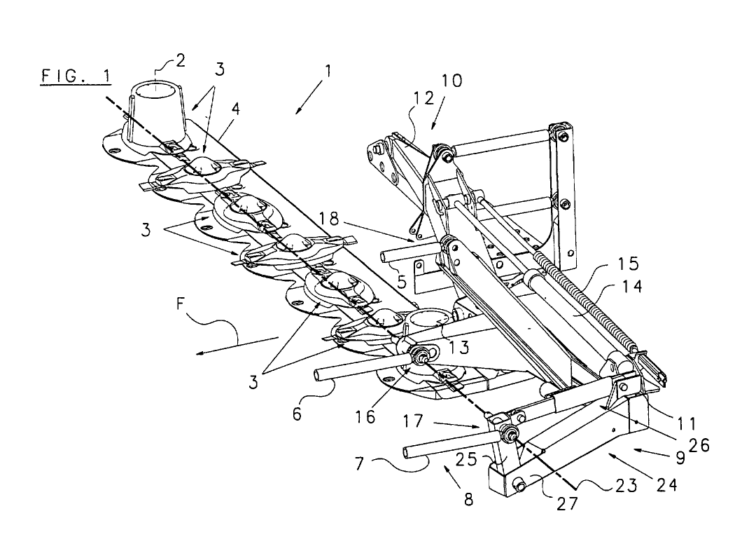

One embodiment of a mowing machine according to the invention is illustrated in detail in FIG. 1. The illustrated mowing machine comprises a mowing device 1 that is guided in the working and operating position laterally on an agricultural support vehicle. The mowing device 1 comprises a number of cutting members 3 rotating about a vertical axis 2. Such machines are used for harvesting grass or similar agricultural crops. The mowing device 1 is comprised of a mowing beam 4 which serves for supporting and driving the rotary cutting members 3. For adaptation to different kinds of applications or crops to be harvested, the mowing device 1 can have arranged downstream thereof a well-known processing unit, not illustrated, which is provided to break up the crops to a greater extent so that the subsequent drying process can be shortened. For connecting the mowing machine to the agricultural support vehicle, in particular, for attachment on the lifting device 8, comprised of an upper rod 5 and lower rods 6, 7, a three-point hitch 9 is provided which, in turn, is connected to a support beam 10 which extends at least approximately transversely to the traveling and working direction F. At the outer end of the support beam 10 the mowing device 1 is pivotably connected by means of a so-called centroidal suspension. The support beam 10 is divided for this purpose into a section 11 fixedly connected with the three-point hitch 9 and a pivotable section 12 wherein the pivotable section 12 is supported on the section 11 so as to be pivotable about the axis 13 which is oriented in the traveling and working direction F. By means of this separation of the support beam 10, the mowing device 1 can be moved by a hydraulic piston-cylinder arrangement 14 from a lateral working and operating position on the support vehicle into an almost vertical transport position and back. A spring 15 arranged approximately parallel to the hydraulic piston-cylinder arrangement 14 serves for adjustment of the contact force of the mowing device 1 on the ground surface and thus for adaptation of the mowing machine to different applications and harvesting conditions.

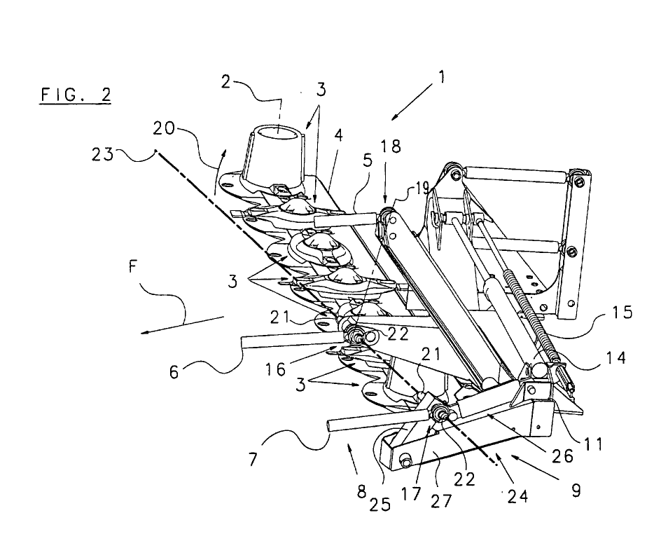

As can be seen also in FIG. 1, the three-point hitch 9 has connecting locations 16, 17 for the lower rods 6, 7 and a connecting location 18 for the upper rod 5. The connecting location 16 on the side of the three-point hitch 9 facing the mowing device 1 and the connecting location 18 are fixed points of the three-point hitch 9 while the connecting location 17 according to the invention provided on the side facing away from the mowing device 1 is arranged on the three-point hitch 9 so as to yield in a direction opposite to the traveling and working direction F. With this configuration of the three-point hitch 9, a pivot movement, illustrated in FIG. 2, of the mowing device 1 about an axis 19 extending through the connecting location 16 of the rod 6 and through the connecting location 18 of the upper rod 5 is carried out when the mowing device 1 impacts during mowing on a rock or a similar obstacle.

This pivot movement is comprised of two partial movements wherein a first partial movement is a pivot movement of the mowing device 1 which occurs in a plane parallel to the ground surface but opposite to the traveling and working direction F while the second partial movement is a lifting movement of the leading area of the mowing device 1, leading relative to the traveling and working direction, in a direction indicated by the arrow 20. A comparison of the positions of the mowing device 1 in FIGS. 1 and 2 relative to the center axis 23 extending through the lower rod journals 21, 22 of the connecting locations 16,17 illustrates the pivot movement of the mowing device 1 which facilitates traversing a rock or similar obstacles.

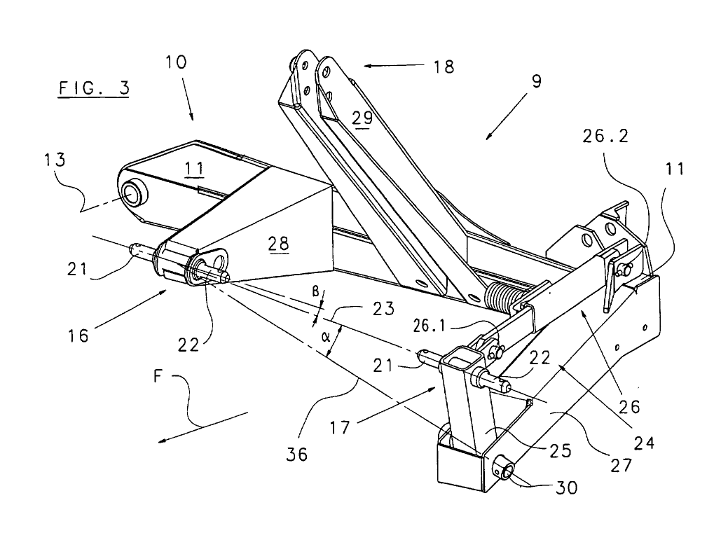

An advantageous embodiment of a three-point hitch 9 according to the invention is illustrated in FIG. 3, wherein the connecting location 17 is a part of a three-member rod arrangement 24 which is comprised of a rod 25 receiving the lower rod journals 21, 22, a strut 26 supporting the rod 25, and a support arm 27 which is embodied as a stationary base member and is fixedly mounted on the section 11 of the support beam 10. The connecting location 16, also provided with lower rod journals 21, 22, as well as the connecting location 18 receiving the upper rod 5 are mounted on support arms 28, 29 of the three-point hitch 9 connected fixedly to the section 11 of the support beam 10.

As is also illustrated in FIG. 3, the rod 25 for forming a connecting location 17, which is arranged on the three-point hitch 9 so as to be yielding in a direction counter to the traveling and working direction F, is pivotably supported by means of a bearing bolt 30 on the support arm 27 and is aligned such that the rod 21 can be pivoted from its initial position in a direction opposite to the traveling and working direction F once a predetermined securing force has been surpassed which is provided by the strut 26. For this purpose, this strut 26 is connected with its first end by a bolt connection 26.1 to brackets mounted on the rearward side of the rod 25, while the second end of the strut 26 is pivotably suspended by an additional bolt connection 26.2 to brackets mounted on the fixed section 11 of the support beam 10.

A conceivable alternative for a connection between the strut 26 and the rod 25 by means of the bolt connection 26.1 could also be provided in that the strut 26 is directly connected to one of the a lower journals 21, 22.

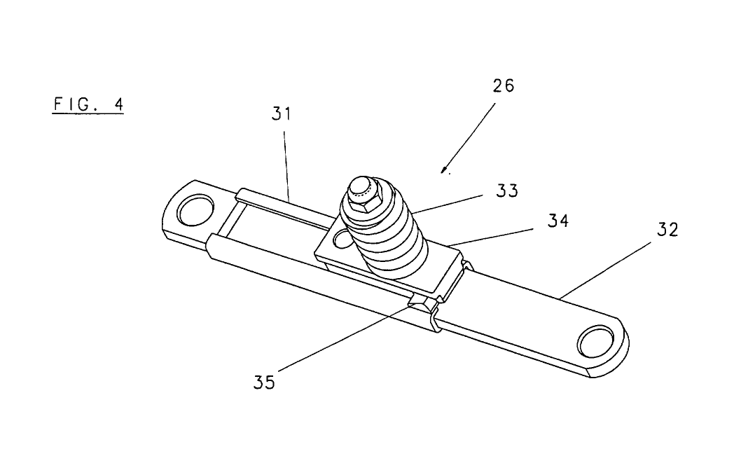

A constructively simple form of the strut 26, which is embodied as a pressure strut and illustrated in FIG. 4, is comprised of two sections 31, 32 which can be inserted into one another wherein the inner section 32 is secured by a locking pawl 34, pretensioned by a pressure spring 33 and interacting with a securing pawl 35 of the outer section 31 and thus providing the securing force, in a position in which the strut 26 has its greatest length. For adaptation to different working and operating conditions, the pretension force of the pressure spring 33 can be adjusted with regard to its magnitude.

According to another advantageous embodiment of the invention, it can be provided that the support of the rod 25 of the rod arrangement 24 is configured such that the lower rod journal(s) 21, 22 of the connecting location 17 at the side of the three-point hitch 9 facing away from the mowing device 1 can follow, when the rod 25 carries out a pivot movement from the initial position, the pivot movement of the mowing device 1 upon impacting on a rock or a similar obstacle (FIGS. 2 and 3). This means that during the pivot movement of the mowing device 1, initiated upon impact on a rock or similar obstacle, whose point of rotation is located in the area of the lower rod journal 22 of the connecting location 16 on the side of the three-point hitch 9 facing the mowing device 1, the rod 25 of the rod arrangement 24 is pivoted out of its initial position in a direction opposite to the traveling and working direction F and the lower rod journal(s) 21, 22 of the connecting location 17 on the side facing away from the mowing machine 1 move approximately on a circular path about the lower rod journal 22 of the connecting location 16 facing the mowing device. In this way, stress between the laterally locked lower rods 6, 7 (FIG. 2) of the lifting device 8 is advantageously prevented in practical use.

In order to achieve these follower properties, the support of the rod 25 of the rod arrangement 24 is configured such that a pivot axis 36 extending through a bearing bolt 30 of the rod 25 of the rod arrangement 24 is positioned at an angle α to a center axis 23 extending through the lower rod journals 21, 22 of the connecting locations 16, 17 and at least in the area of the lower rod journals 22 of the connecting location 16 intercepts the center axis at the side of the three-point hitch 9 facing the mowing device 1 (FIG. 3).

When employing two lower rod journals 21, 22 at the connecting location 16, the position of the bearing bolt 30 of the rod 25 according to the invention can be aligned such that it intercepts the center axis 23 extending through the lower rod journals 21, 22 in an area located approximately centrally between the lower rod journals 21, 22 of the connecting locations 16. The pivot axis 36 and the central axis 23 are positioned preferably in a plane extending at least somewhat vertically and transversely to the traveling and working direction F.

A further advantageous aspect of the invention results when the lower rod journals 21, 22 of the connecting location 16 are arranged in a horizontal plane relative to the plane of the drawing of FIG. 3 rotated about an angle β relative to the central axis 23. In this way, the possibility is provided to enlarge the maximum pivot angle of the mowing device 1 (FIG. 2), which depends on the size of the pivot angle of the ball-and-socket joint on the lower rod 6 that is determined by the device construction, upon impact on a rock or similar obstacle.

In a further embodiment of the invention by using a hydraulic piston-cylinder arrangement loadable by a pressure force in place of the strut 26 an advantageous embodiment of a rod arrangement can result wherein the hydraulic piston-cylinder arrangement cooperates with its pressure connector with a hydraulic storage device. This provides the possibility of an automatic return of the initial strut length, for example, after the mowing device 1 has impacted on and traversed a rock or a similar obstacle.

Even though in the description and the corresponding drawings advantageous embodiments have already been described, within the context of the invention further modifications are conceivable. As an example, one embodiment should be mentioned in which the connecting location 17 on the side of the three-point hitch 9 facing away from the mowing device 1 is provided with a support arm which is length-changeable in a telescoping way. For this purpose, springs or similar force storage means could be used in order to secure the support arm in its extended position and a transfer into the retracted position would be allowed only upon surpassing a predetermined securing force.

While specific embodiments of the invention have been shown and described in detail to illustrate the inventive principles, it will be understood that the invention may be embodied otherwise without departing from such principles.

What is claimed is:

1. A mowing machine connectable to a lifting device arranged at the rear end of an agricultural support vehicle; the mowing machine comprising:
a mowing device (1) guided in a working and operating position laterally by a support vehicle, wherein the mowing device (1) comprises several rotary cutting members (3) rotating about an approximately vertical axis, respectively;
a support beam (10) having a first end configured to receive the mowing device (1) and a second end comprising a three-point hitch (9) with connecting locations configured to connect upper and lower rods of the lifting device;
wherein a first one of the connecting locations (17) is provided on the support beam (10) on a side of the three-point hitch (9) facing away from the mowing device (1);
wherein the first connecting location (17) is connected to the three-point hitch (9) such that, upon impacting of the mowing device (1) on an obstacle, when the mowing machine is moving in a traveling and working direction (F), a pivot movement of the mowing device (1) in a direction counter to the travel and working direction (F) and a lifting movement of a leading area of the mowing device (1), leading relative to the traveling and working direction (F), are initiated.

2. The mowing machine according to claim 1, wherein the first connecting location (17) is connected to the three-point hitch (9) so as to yield in the direction counter to the traveling and working direction (F).

3. The mowing machine according to claim 2, wherein the connection between the three-point hitch (9) and the connecting location (17) is released only upon surpassing a predetermined securing force.

4. The mowing machine according to claim 1, wherein the three-point hitch (9) comprises:
a support arm (27);
a rod (25) comprising at least one lower rod journal (21, 22) and supported on the support arm (27);
a length-adjustable strut (26) supporting the rod (25) in an initial position of the rod (25);
wherein the first connecting location (17) is provided on the rod (25).

5. The mowing machine according to claim 4, wherein the rod (25), the strut (26), and the support arm (27) together form a rod arrangements (24).

6. The mowing machine according to claim 5, wherein the rod (25) and the strut (26) are located above support arm (27).

7. The mowing machine according to claim 5, wherein the rod (25) and the strut (26) are located underneath the support arm (27).

8. The mowing machine according to claim 4, wherein a second one of the connecting locations (16) is provided on a side of the three-point hitch (9) facing the mowing device (1) and comprises at least one second lower rod journal (21, 22).

9. The mowing machine according to claim 8, wherein the rod (25) is arranged to be pivotable about a pivot axis (36) positioned at an angle (α) to a central axis (23) extending through the at least one first lower rod journal (21, 22) of the first connecting location (17) and through the at least one second lower rod journal (21, 22) of the second connecting location (16).

10. The mowing machine according to claim 9, wherein the pivot axis (36) intercepts the center axis (23) at least approximately in an area of the at least one second lower rod journal (21 or 22).

11. The mowing machine according to claim 10, wherein the pivot axis (36) intercepts the central axis (23) at least approximately centrally in an area between the second lower rod journals (21, 22) of the second connecting location (16).

12. The mowing machine according to claim 8, wherein the second lower rod journals (21, 22) of the second connecting location (16) are arranged at an angle (β) to a center axis (23) extending through the first lower rod journals (21, 22) of the first connecting location (17).

13. The mowing machine according to claim 4, wherein the strut (26) is a pressure strut.

14. The mowing machine according to claim 13, wherein the strut (26) comprises a locking pawl (34) and a pressure spring (33) pretensioning the locking pawl (34), and further comprises a securing pawl (35) cooperating with the locking pawl (34), wherein the strut (26) is secured by the locking pawl (34) in an extended position and is transferable into a retracted position only upon surpassing a predetermined securing force.

15. The mowing machine according to claim 14, wherein a pretensioning force of the pressure spring (33) is adjustable.

16. The mowing machine according to claim 4, wherein the strut (26) is a hydraulic piston-cylinder arrangement loadable by a pressure force and provided with a pressure connector cooperating with a hydraulic storage devices.

17. The mowing machine according to claim 1, wherein the first connecting location is provided with at least one lower rod journal secured on a support arm having a telescopically adjustable length.

18. The mowing machine according to claim 17, wherein the telescopically adjustable support arm is secured in an extended position by a spring or a force storage means and is transferable into a retracted position only upon surpassing a predetermined securing force.
